(19) United States
(12) Patent Application Publication
(10) Pub. No.: US 2026/0351158 A1
(43) Pub. Date: Nov. 5, 2026

(54) Display Device And Electronic Device Including Same

(71) Applicant: Samsung Display Co., Ltd., Yongin-si (KR)

(72) Inventors: SEONGJOO LEE, Yongin-si (KR); OHJO KWON, Yongin-si (KR); SANGMYEON HAN, Yongin-si (KR)

(73) Assignee: Samsung Display Co., Ltd., Yongin-si (KR)

(21) Appl. No.: 19/653,462

(22) Filed: Apr. 21, 2026

(30) Foreign Application Priority Data
Apr. 30, 2025 (KR) 10-2025-0057364

(51) Int. Cl. G09G 3/20

(52) U.S. Cl. CPC G09G 3/2092; G09G 2310/0297; G09G 2330/021; G09G 2330/12

(57) ABSTRACT

A display device is provided that includes a display panel, one or more data drivers and a driving controller. The display panel includes one or more data lines and a plurality of pixels. Each pixel is connected to a data line, and each data line has a first end and a second end. Each data driver includes an output buffer. The output butter is connected to a respective data line at the first end of the data line. The output buffer is configured to provide a data voltage to the respective data line with which it is connected. The driving controller is configured to control each data driver. The display panel further includes a test buffer. The test buffer is connected to each data line at the second end of the data line.

### CROSS-REFERENCE TO RELATED APPLICATION

This application claims priority to and the benefit of Korean Patent Application No. 10-2025-0057364, filed on Apr. 30, 2025, the disclosure of which is incorporated by reference herein in its entirety.

### TECHNICAL FIELD

The present disclosure relates to a display device and an electronic device that includes the display device.

### BACKGROUND

In general, a display device includes a display panel and a display panel driver. The display panel includes gate lines, data lines, emission lines, and pixels. The display panel driver includes a gate driver for providing a gate signal to the gate lines, a data driver for providing a data voltage to the data lines, an emission driver for providing an emission signal to the emission lines, and a driving controller for controlling the gate driver, the data driver, and the emission driver.

The data driver may include an output buffer connected to the data lines that provides the data voltage to the data lines. While the data voltage output from the output buffer is transmitted through the data lines, a slew rate (SR) of the data voltage may be reduced. When the slew rate of the data voltage is small, a charging time of the pixel may become long, and a display quality of the display device may deteriorate.

In a process step of the display device (e.g., an Electrical Die Sorting (EDS) step), the slew rate of the data voltage transmitted through the data lines may be tested. Specifically, for a portion of the data line, the slew rate of the data voltage may be tested using a probe connected to measurement equipment, such as an oscilloscope.

However, in a case of a point distant from the output buffer of the display panel, an interval between the data lines is narrow. Thus, a problem may occur in that testing the slew rate of the data voltage becomes difficult.

### BRIEF SUMMARY

The disclosure is intended to solve problems including improving methods of testing the slew rate of data voltage. More particularly, the present disclosure describes a display device that includes the display device. In some aspects, the display device includes a test buffer for testing a slew rate of a data voltage transmitted through a data line.

In some aspects, the present disclosure provides an electronic device that includes the display device.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to some aspects of the present disclosure, a display device is provided that includes a display panel, one or more data drivers, and a driving controller. Each data driver of the one or more data drivers includes an output buffer connected to a respective data line of the one or more data lines at the first end of the data line, and the output buffer is configured to provide a data voltage to the respective data line with which the output buffer is connected. The display panel includes one or more data lines and a plurality of pixels. Each pixel of the plurality of pixels is connected to a data line of the one or more data lines, and each data line of the one or more data lines has a first end and a second end. The driving controller is configured to control each data driver of the one or more data drivers. The display panel further includes a test buffer connected to each data line of the one or more data lines at the second end of the data line.

In some aspects, a slew rate of the output buffer is determined such that a slew rate of a data voltage of the second end of the data line of each data driver is equal to or greater than a threshold slew rate.

In some aspects, a slew rate of the test buffer is greater than a slew rate of the output buffer.

In some aspects, a bias current of the test buffer is greater than a bias current of the output buffer.

In some aspects, the display panel further includes one or more multiplexers connected to the test buffer. In some aspects, a multiplexer of the one or more multiplexers is configured to connect one data line of the one or more data lines to the test buffer in response to receiving a selection signal. In some aspects, the one or more data lines includes at least two data lines.

In some aspects, the one or more multiplexers includes at least two multiplexers.

In some aspects, the display panel further includes a first switch connected between an input terminal of the test buffer and an output terminal of the multiplexer, a second switch connected between a test pad and the output terminal of the multiplexer, and a third switch connected between the test pad and an output terminal of the test buffer.

In some aspects, in a testing step, the first switch and the third switch are closed and the second switch is open. In a normal driving step other than the testing step, the first switch and the third switch are open and the second switch is closed.

In some aspects, in the testing step, a slew rate of the data voltage output from the output terminal of the test buffer is tested.

In some aspects, the data driver and the driving controller are included in a display panel driver.

In some aspects of the present disclosure, an electronic device is provided that includes a display panel, one or more data drivers, a driving controller, and a processor. The display panel includes one or more data lines and a plurality of pixels. Each pixel of the plurality of pixels is connected to a data line of the one or more data lines. Each data line has a first end and a second end. Each data driver of the one or more data drivers includes an output buffer connected to a respective data line of the one or more data lines at the first end of the data line, and the output buffer is configured to provide a data voltage to the respective data line with which the output buffer is connected. The driving controller is configured to control each data driver of the one or more data drivers. The processor is configured to control the driving controller. The display panel further includes a test buffer connected to each data line of the one or more data lines at the second end of the data line.

In some aspects, a slew rate of the output buffer is determined such that a slew rate of a data voltage of the second end of the data line of each data driver is equal to or greater than a threshold slew rate.

In some aspects, a slew rate of the test buffer is greater than a slew rate of the output buffer.

In some aspects, a bias current of the test buffer is greater than a bias current of the output buffer.

In some aspects, the display panel further includes one or more multiplexers connected to the test buffer. In some aspects, a multiplexer of the one or more multiplexers is configured to connect one data line of the one or more data lines to the test buffer in response to receiving a selection signal. In some aspects, the one or more data lines includes at least two data lines.

In some aspects, the one or more multiplexers include at least two multiplexers.

In some aspects, the display panel further includes a first switch connected between an input terminal of the test buffer and an output terminal of the multiplexer, a second switch connected between a test pad and the output terminal of the multiplexer, and a third switch connected between the test pad and an output terminal of the test buffer.

In some aspects, in a testing step, the first switch and the third switch are closed and the second switch is open. In a normal driving step other than the testing step, the first switch and the third switch are open and the second switch is closed.

In some aspects, in the testing step, a slew rate of the data voltage output from the output terminal of the test buffer is tested.

In some aspects, the data driver and the driving controller are included in a display panel driver.

In some aspects of the present disclosure, the display panel of the display device or the electronic device further includes the test buffer connected to the one or more data lines at the second end of the respective data line. The output buffer is connected to the first end of the respective data line. Accordingly, without physically scratching the second end of the data line to expose the second end of the data line, the data voltage of the second end of the data line output from the test buffer may be tested.

### BRIEF DESCRIPTION OF THE DRAWINGS

The above and other aspects and features of the present disclosure will become more apparent by describing in detail example embodiments thereof with reference to the accompanying drawings, in which:

FIG. 1 is a block diagram showing a display device according to embodiments of the present disclosure;

FIG. 2 is a circuit diagram showing an output buffer and data lines according to a comparative example;

FIG. 3 is a conceptual diagram showing a slew rate of an output buffer of FIG. 2;

FIG. 4 is a conceptual diagram showing a slew rate of a data voltage transmitted through a data line of FIG. 2;

FIG. 5 is a diagram showing data lines and pixels of FIGS. 2-4;

FIG. 6 is a circuit diagram showing a display panel including an output buffer and a data line according to embodiments of the present disclosure;

FIG. 7 is a circuit diagram showing an operation of an output buffer and a data line of FIG. 6 in a test step;

FIG. 8 is a circuit diagram showing an operation of an output buffer and a data line of FIG. 6 in a normal driving step;

FIG. 9 is a circuit diagram showing an example of a display panel including an output buffer and a data line according to embodiments of the present disclosure;

FIG. 10 is a block diagram showing an electronic device according to an embodiment of the present disclosure;

FIG. 11 is a diagram showing an example in which an electronic device of FIG. 10 is implemented as a smart phone;

FIG. 12 is a block diagram showing an electronic device according to an embodiment of the present disclosure; and

FIG. 13 is schematic diagrams showing electronic devices of FIG. 12.

### DETAILED DESCRIPTION

While specific embodiments are shown in the drawings and described in detail herein below, the present disclosure may be modified in various different ways and realized in many different forms. Accordingly, it will be appreciated that the present disclosure is not limited to the specific disclosed forms, and should be construed to include all modifications, equivalents, or replacements included within the spirit and scope of the present disclosure.

Hereinafter, example embodiments of the present disclosure will be described in more detail with reference to the accompanying drawings. When describing with reference to the drawings, identical or corresponding components or elements are designated by the same reference numerals and redundant descriptions are thereof omitted.

It is further to be understood that, in the drawing, sizes, dimensions, ratios, angles, numbers of elements, and thicknesses, and the like, may be exaggerated or reduced for convenience of explanation. For example, a size and thickness of each component shown in the drawings are arbitrarily shown to facilitate understanding and ease of description, and thus the implementation of the teachings of the present disclosure is not necessarily limited to what is shown.

It should be understood that when an element such as a layer, film, region, or substrate is referred to as being “on” another element, it can be directly on the other element or intervening elements may also be present. In contrast, when an element is referred to as being “directly on” another element, there are no intervening elements present.

It is to be understood that, although the terms such as “first”, “second”, etc. may be used herein to describe various elements, these elements should not be limited by these terms. These terms are used to distinguish one element from another element. For instance, a first element may be termed a second element without departing from the teachings of the present disclosure. Similarly, the second element could also be termed a first element.

In the examples below, singular expressions include plural expressions unless the context clearly indicates otherwise.

In the examples below, terms such as “comprise/comprising,” “include/including,” or “have/having” mean that a feature or component described in the specification is present, and the terms do not exclude in advance the possibility that one or more other features or components may be added.

It is to be understood that, “A and/or B” refers to either A, B, or both A and B; and “at least one of A and B” indicates the case where it is A, or B, or both A and B.

Features of various example embodiments of the present disclosure may be combined partially or totally. As will be clearly appreciated by those skilled in the art, technically various interactions and operations are possible. Various example embodiments can be practiced individually or in combination.

It is to be understood that, where the implementation is otherwise feasible, specific process sequences may be performed in a different order than described. For example, two processes described sequentially may be performed substantially simultaneously, or may proceed in the reverse order from that described.

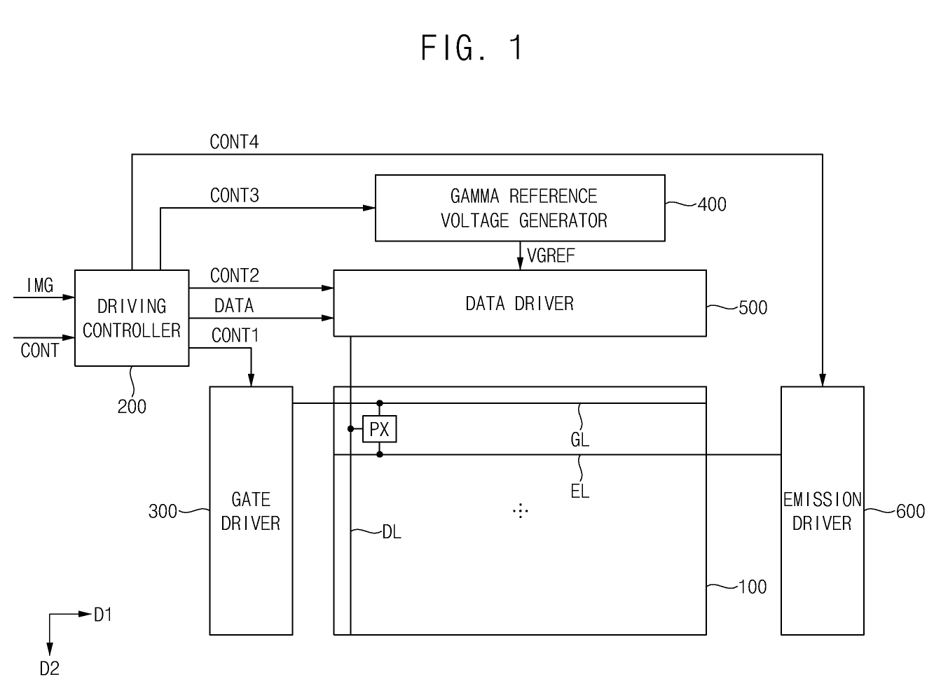

Further, first and second directions can be defined, such as D1 and D2, as shown in FIG. 1. A plane can then be defined by a first line in the direction of D1 and a second line in the direction of D2, where the second line is transverse to the first line. In addition, a third line can be defined in a direction D3 which is perpendicular to the plane.

A display device, according to some aspects, may be included in other electronic devices. In some aspects, the display device may further include a module or device having additional functions in addition to the display function.

FIG. 1 is a block diagram showing a display device according to embodiments of the present disclosure.

Referring to FIG. 1, a display device may include a display panel 100 and a display panel driver. The display panel driver may include a driving controller 200, a gate driver 300, a gamma reference voltage generator 400, and a data driver 500. The display panel driver may further include an emission driver 600.

For example, the driving controller 200 and the data driver 500 may be formed integrally. For example, the driving controller 200, the gamma reference voltage generator 400, and the data driver 500 may be formed integrally. For example, the driving controller 200, the gate driver 300, the gamma reference voltage generator 400, and the data driver 500 may be formed integrally. For example, the driving controller 200, the gate driver 300, the gamma reference voltage generator 400, the data driver 500, and the emission driver 600 may be formed integrally. Meanwhile, a driving module in which at least the driving controller 200 and the data driver 500 are formed integrally may be named a timing controller embedded data driver (TED).

The display panel 100 may include a display area for displaying an image and a peripheral area disposed adjacent to the display area.

For example, the display panel 100 may be an organic light-emitting diode display panel including an organic light-emitting diode. For another example, the display panel 100 may be a quantum-dot organic light-emitting diode display panel including an organic light-emitting diode and a quantum-dot color filter. For another example, the display panel 100 may be a quantum-dot nano light-emitting diode display panel including a nano light-emitting diode and a quantum-dot color filter. For another example, the display panel 100 may be a liquid crystal display panel including a liquid crystal layer.

The display panel 100 may include gate lines GL, data lines DL, emission lines EL, and pixels PX electrically connected to the gate lines GL, the data lines DL, and the emission lines EL, respectively. The gate lines GL may extend in a first direction D1, the data lines DL may extend in a second direction D2 crossing the first direction D1, and the emission lines EL may extend in the first direction D1.

The driving controller 200 may receive input image data IMG and an input control signal CONT from an external device (not shown). For example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The gate driver 300 may generate gate signals for driving the gate lines GL in response to the first control signal CONT1 received from the driving controller 200. The gate driver 300 may output the gate signals to the gate lines GL.

In an embodiment, the gate driver 300 may be integrated on the peripheral area of the display panel 100.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

For example, the gamma reference voltage generator 400 may be disposed within the driving controller 200 or may be disposed within the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into a data voltage having an analog type using the gamma reference voltage VGREF. The data driver 500 may output the data voltage to the data line DL.

The emission driver 600 may generate emission signals for driving the emission lines EL in response to the fourth control signal CONT4 received from the driving controller 200. The emission driver 600 may output the emission signals to the emission lines EL.

In an embodiment, the emission driver 600 may be integrated in the peripheral area of the display panel 100. In an embodiment, the emission driver 600 may be mounted in the peripheral area of the display panel 100.

In FIG. 1, for a convenience of an explanation, the gate driver 300 may be disposed on a first side of the display panel 100 and the emission driver 600 may be disposed on a second side of the display panel 100. Although shown, the teachings of the present disclosure is not limited thereto. For example, both the gate driver 300 and the emission driver 600 may be disposed on the first side of the display panel 100. For example, both the gate driver 300 and the emission driver 600 may be disposed on both sides of the display panel 100. For example, the gate driver 300 and the emission driver 600 may be formed integrally.

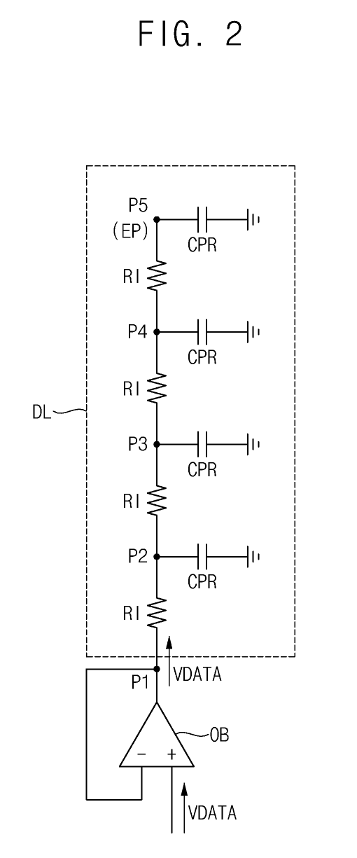

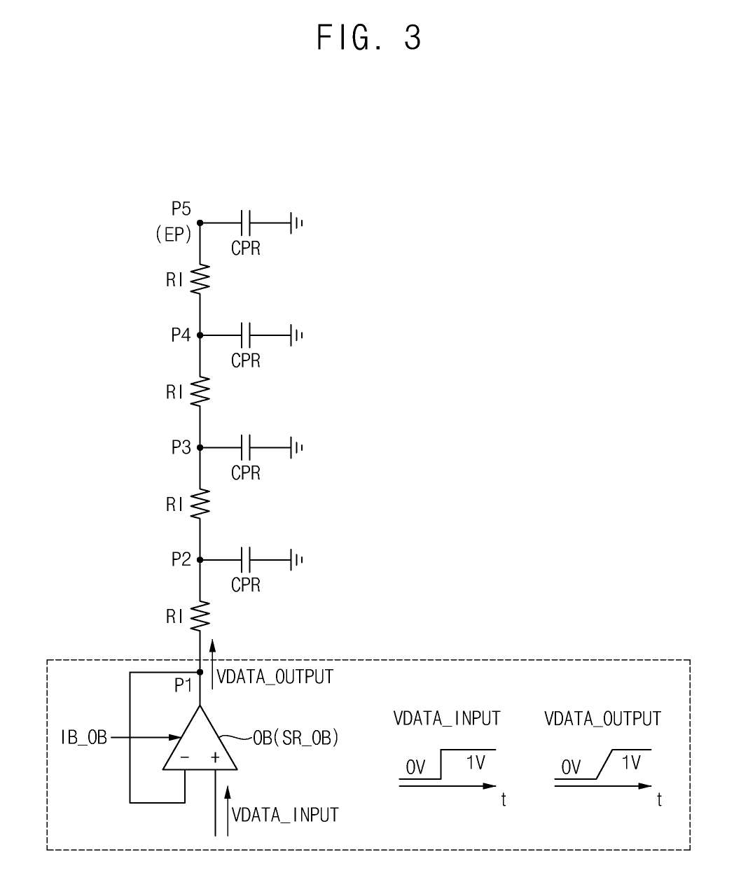

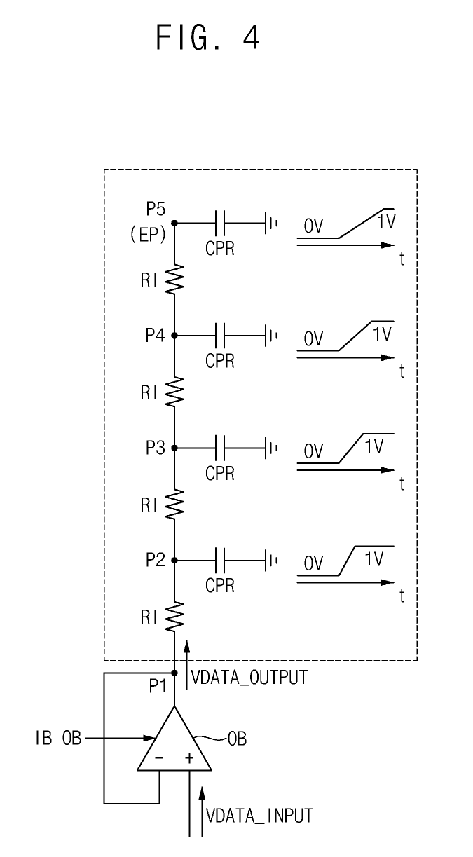

FIG. 2 is a circuit diagram showing an output buffer OB and data lines DL according to a comparative example. FIG. 3 is a conceptual diagram showing a slew rate SR_OB of an output buffer OB of FIG. 2. FIG. 4 is a conceptual diagram showing a slew rate of a data voltage VDATA transmitted through a data line DL of FIG. 2.

Referring to FIGS. 1 and 2, a data driver 500 may include an output buffer OB, and a display panel 100 may include a data line DL connected to the output buffer OB.

The data driver 500 may generate a data voltage VDATA based on a data signal DATA received from a driving controller 200. The output buffer OB may include an input terminal, an inverting input terminal, and an output terminal. The input terminal of the output buffer OB may receive the data voltage VDATA. The inverting input terminal and the output terminal of the output buffer OB may be connected to each other. The output terminal of the output buffer OB may output the data voltage VDATA, and the output buffer OB may provide the data voltage VDATA to the data line DL.

The data voltage VDATA transmitted through the data line DL may be provided to pixels PX connected to the data line DL. For example, each of the pixels PX may include a driving transistor, a data write transistor, and a light emitting element. The data write transistor may provide the data voltage VDATA to the driving transistor, the driving transistor may generate a driving current based on the data voltage VDATA, and the light emitting element may emit a light in response to the driving current.

The data line DL may include an internal resistance RI and a parasitic capacitor CPR. For example, a resistance of the internal resistance RI and a capacitance of the parasitic capacitor CPR may be relatively small when observed at a first point P1. For example, the resistance of the internal resistance RI and the capacitance of the parasitic capacitor CPR may be relatively greater at a second point P2 than at the first point P1. For example, the resistance of the internal resistance RI and the capacitance of the parasitic capacitor CPR may be relatively greater at a third point P3 than at the second point P2. For example, the resistance of the internal resistance RI and the capacitance of the parasitic capacitor CPR may be relatively greater at a fourth point P4 than at the third point P3. For example, the resistance of the internal resistance RI and the capacitance of the parasitic capacitor CPR may be relatively greater at a fifth point P5 than at the fourth point P4.

Referring to FIGS. 1 to 3, a voltage output from an output terminal of a buffer may vary according to a voltage input to an input terminal of the buffer, and the voltage of the input terminal of the buffer and the voltage the output terminal of the buffer may be identical, such that a gain is 1. However, the voltage output from the output terminal of the buffer may vary with a delay time. The delay time may be represented as a slew rate (SR). The slew rate means a rate of voltage change per unit time (i.e., a slope). For example, when the delay time is short, the slew rate may be large, and when the delay time is long, the slew rate may be small.

For example, when the data voltage VDATA input to the input terminal of the output buffer OB may change instantaneously from 0 V to 1 V. In this case, a data voltage VDATA output from an output terminal of an output buffer OB which ideally operates should change instantaneously from 0 V to 1 V. However, a data voltage VDATA output from an output terminal of an output buffer OB which actually operates may change from 0 V to 1 V with the delay time.

In order to operate ideally, a slew rate SR_OB of the output buffer OB should be a large. The slew rate SR_OB of the output buffer OB may be controlled based on a bias current IB_OB applied to the output buffer OB. For example, when the bias current IB_OB is large, the slew rate SR_OB may be large. For example, when the bias current IB_OB is small, the slew rate SR_OB may be small.

As such, a slew rate of the data voltage VDATA transmitted through the data line DL may be determined based on the slew rate SR_OB of the output buffer OB.

However, when the bias current IB_OB of the output buffer OB is large, a charging time of the pixels PX may be short, but a power consumption of a display device may increase. When the bias current IB_OB of the output buffer OB is small, the charging time of the pixels PX may be long, but the power consumption of the display device may be small. Therefore, it may be important to adjust the bias current IB_OB of the output buffer OB such that the slew rate SR_OB of the output buffer OB may be large and the power consumption of the display device may be small.

Referring to FIGS. 1 to 4, the slew rate of the data voltage VDATA transmitted through the data line DL may be determined not only based on the slew rate SR_OB of the output buffer OB but also based on a distance from the output buffer OB.

A time constant due to the internal resistance RI and the parasitic capacitor CPR of the data line DL may be determined based on the distance from the output buffer OB. As a distance from the output buffer OB increases, the internal resistance RI and the parasitic capacitance CPR of the data line DL may increase, the time constant may increase, and the slew rate of the data voltage VDATA transmitted through the data line DL may decrease.

For example, the resistance of the internal resistance RI and the capacitance of the parasitic capacitor CPR may be relatively small when observed at the first point P1. Therefore, the time constant at the first point P1 may be small, and the slew rate of the data voltage VDATA transmitted through the data line DL may be relatively large at the first point P1.

For example, the resistance of the internal resistance RI and the capacitance of the parasitic capacitor CPR may be relatively greater at the second point P2 than at the first point P1. Therefore, the time constant may be greater at the second point P2 than at the first point P1, and the slew rate of the data voltage VDATA transmitted through the data line DL may be relatively less at the second point P2 than at the first point P1.

For example, the resistance of the internal resistance RI and the capacitance of the parasitic capacitor CPR may be relatively greater at the third point P3 than at the second point P2. Therefore, the time constant may be greater at the third point P3 than at the second point P2, and the slew rate of the data voltage VDATA transmitted through the data line DL may be relatively less at the third point P3 than at the second point P2.

For example, the resistance of the internal resistance RI and the capacitance of the parasitic capacitor CPR may be relatively greater at the fourth point P4 than at the third point P3. Therefore, the time constant may be greater at the fourth point P4 than at the third point P3, and the slew rate of the data voltage VDATA transmitted through the data line DL may be relatively less at the fourth point P4 than at the third point P3.

For example, the resistance of the internal resistance RI and the capacitance of the parasitic capacitor CPR may be relatively greater at the fifth point P5 than at the fourth point P4. Therefore, the time constant may be greater at the fifth point P5 than at the fourth point P4, and the slew rate of the data voltage VDATA transmitted through the data line DL may be relatively less at the fifth point P5 than at the fourth point P4.

As such, the slew rate of the data voltage VDATA transmitted through the data line DL may be determined not only based on the slew rate SR_OB of the output buffer OB but also based on the distance from the output buffer OB.

In summary, the slew rate of the data voltage VDATA transmitted through the data line DL may be smallest at the fourth point P4 (i.e., an end of the data line DL). When the slew rate of the data voltage VDATA is less than a certain level, a vertical line may be recognized in the display device. In order to secure a display quality of the display device, the bias current IB_OB of the output buffer OB may be adjusted to adjust a slew rate of the end of the data line DL.

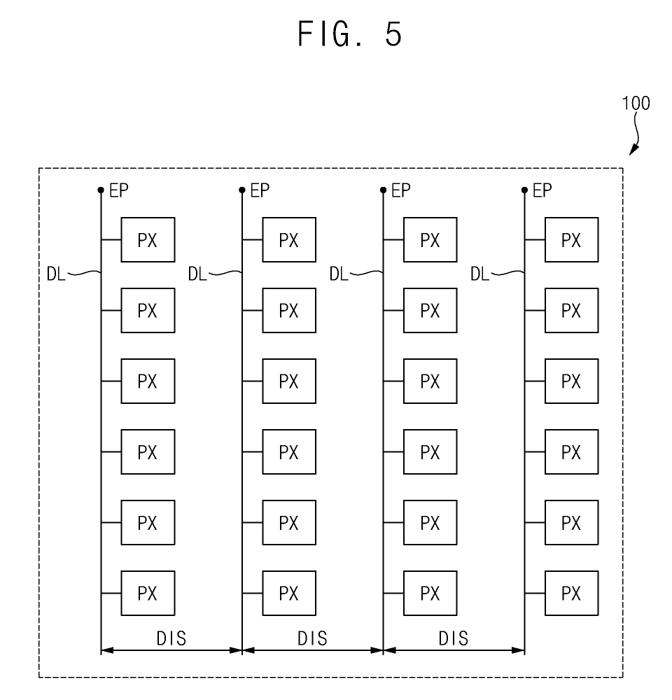

FIG. 5 is a diagram showing data lines DL and pixels PX of FIGS. 2 to 4.

Referring to FIGS. 1 to 5, in order to secure the display quality of the display device, the slew rate of the end EP of the data line DL should be tested.

The display panel 100 may include the data lines DL and the pixels PX connected to the data lines DL. In order to test the slew rate of the end EP of the data line DL, in a processing step (e.g., EDS (Electrical Die Sorting)) of the display device, an end of the display panel 100 may be physically scratched to expose the end EP of the data line DL. Then a probe connected to a measuring equipment such as an oscilloscope may contact the end EP of the data line DL such that the slew rate of the end EP of the data line DL may be tested.

However, an integration density of the display device may be large, and an interval DIS between the data lines DL may be as short as several tens of micrometers or several hundreds of micrometers. Therefore, physically scratching the end of the display panel 100 to expose the end EP of the data line DL may be difficult. Accordingly testing the slew rate of the end EP of the data line DL may be difficult.

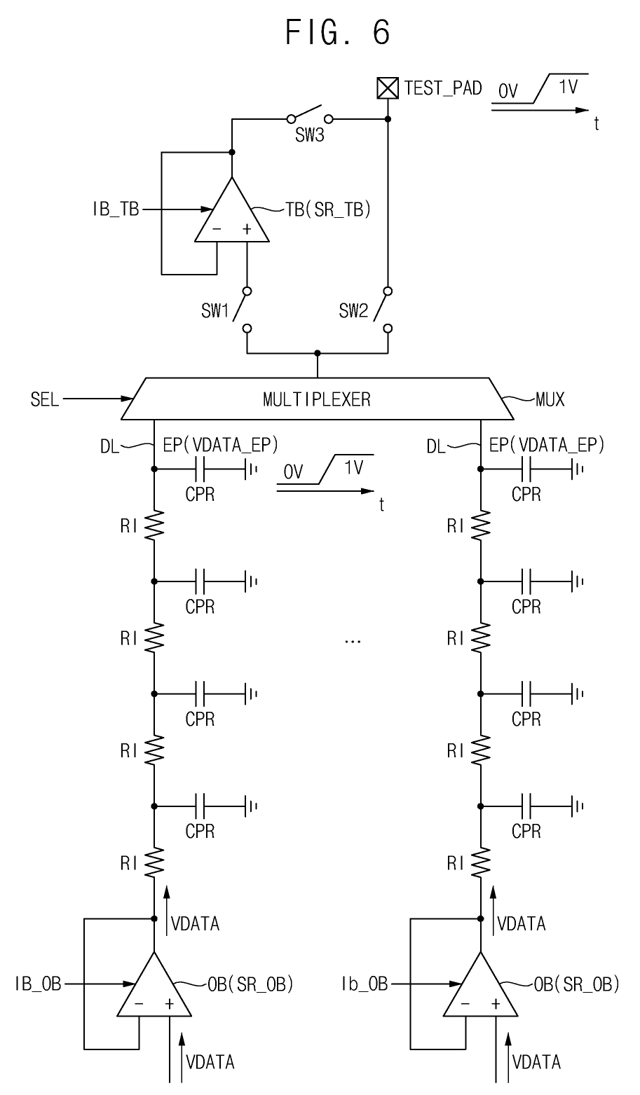

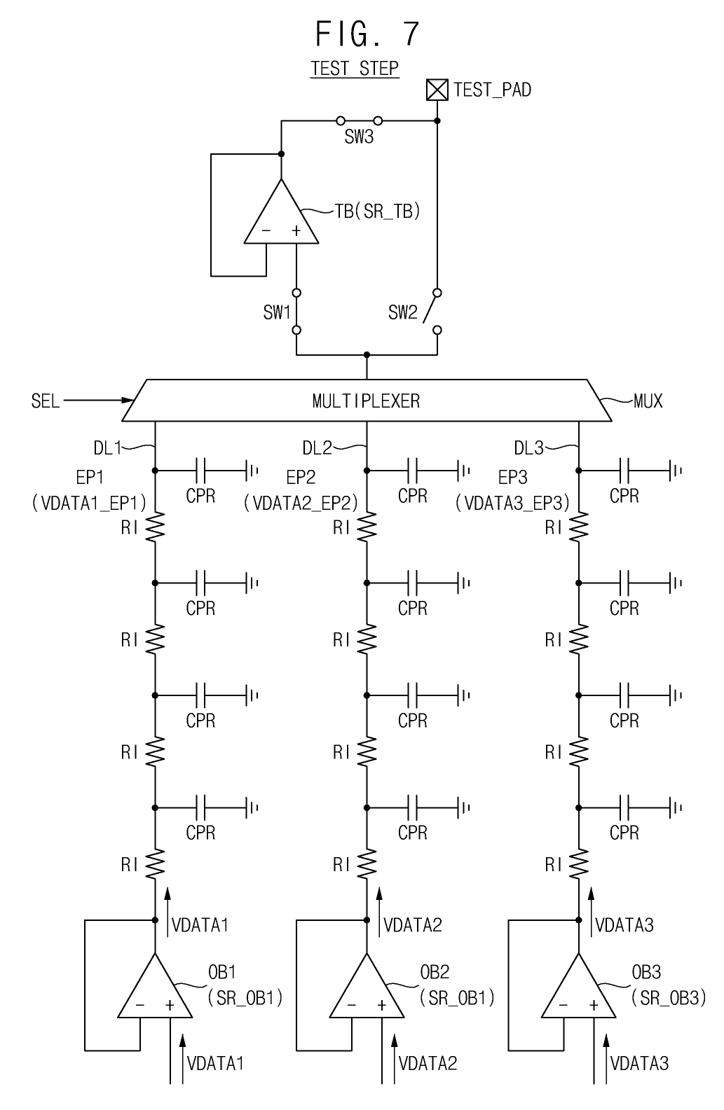

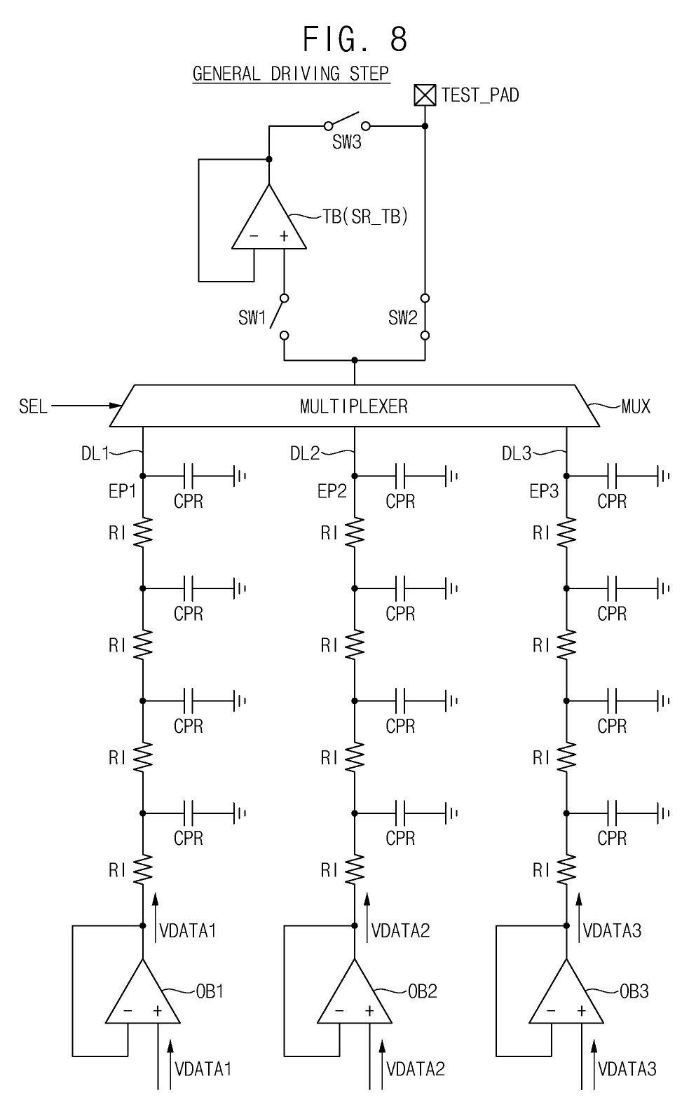

FIG. 6 is a circuit diagram showing a display panel 100 including an output buffer OB and a data line DL according to embodiments of the present disclosure. FIG. 7 is a circuit diagram showing an operation of an output buffer OB and a data line DL of FIG. 6 in a testing step. FIG. 8 is a circuit diagram showing an operation of an output buffer OB and a data line DL of FIG. 6 in a normal driving step.

Referring to FIGS. 1 to 6, the data driver 500 may include the output buffers OB, and the display panel 100 may include the data lines DL connected to the output buffers OB and a test buffer TB connected to the data lines DL in a direction opposite to the output buffers OB. That is, each data line DL has a first end and a second end, the first end of the data line DL is connected to the output buffer OB and the second end of the data line DL is connected to the test buffer TB. In an embodiment, the display panel 100 may further include a multiplexer MUX.

The multiplexer MUX may be connected between at least two data lines DL and the test buffer TB. Specifically, an input terminal of the multiplexer MUX may be connected to ends EP of the data lines DL. an output terminal of the multiplexer MUX may be connected to the test buffer TB. The multiplexer MUX may connect any one of the data lines DL to the test buffer TB in response to a selection signal SEL provided from external inspection equipment. Accordingly, the multiplexer MUX may receive and output a data voltage VDATA_EP transmitted from the ends EP of the data lines DL.

In an embodiment, the display panel 100 may further include switches SW1, SW2, and SW3. For example, the switches SW1, SW2, and SW3 may include a first switch SW1, a second switch SW2, and a third switch SW3. The first switch SW1 may be connected between the output terminal of the multiplexer MUX and the test buffer TB. The second switch SW2 may be connected between the output terminal of the multiplexer MUX and a test pad TEST_PAD. The third switch SW3 may be connected between the test buffer TB and the test pad TEST_PAD.

In a testing step, the first switch SW1 and the third switch SW3 may be closed, and the second switch SW2 may be open. In a normal driving step other than the testing step, the first switch SW1 and the third switch SW3 may be open, and the second switch SW2 may be closed.

The test buffer TB may include an input terminal, an inverting input terminal, and an output terminal. The input terminal of the test buffer TB may receive the data voltage VDATA_EP of the end EP of the data line DL provided from the multiplexer MUX. The inverting input terminal of the test buffer TB and the output terminal of the test buffer TB may be connected to each other. The output terminal of the test buffer TB may output the data voltage VDATA_EP of the end EP of the data line DL.

The output terminal of the test buffer TB may also be connected to the test pad TEST_PAD. Therefore, the output terminal of the test buffer TB may provide the data voltage VDATA_EP of the end EP of the data line DL to the test pad TEST_PAD. The data voltage VDATA_EP of the end EP of the data line DL output from the test pad TEST_PAD may be tested using the probe.

In the test step, the slew rate SR_OB of the output buffer OB may be adjusted such that the data voltage VDATA_EP of the end EP of the data line DL output from the test pad TEST_PAD (i.e., the output terminal of the test buffer TB) may be equal to or greater than a threshold slew rate. Here, the threshold slew rate may correspond to a threshold value at which the vertical line become visible on the display device.

A slew rate SR_TB of the test buffer TB may be greater than the slew rate of the output buffer OB. In an embodiment, the slew rate SR_TB of the test buffer TB may be adjusted based on a bias current IB_TB applied to the test buffer TB, and the bias current IB_TB of the test buffer TB may be greater than the bias current IB_OB of the output buffer OB.

The slew rate of the data voltage VDATA_EP of the end EP of the data line DL may be relatively small. When the slew rate SR_TB of the test buffer TB is small, a voltage output from the test pad TEST_PAD may differ from the slew rate of the data voltage VDATA_EP of the end EP of the data line DL such that a reliability may be low. Therefore, the slew rate SR_TB of the test buffer TB may be determined to be relatively large.

Referring to FIGS. 1 to 7, in the test step, the first switch SW1 and the third switch SW3 may be closed, the second switch SW2 may be open, and the data voltage VDATA_EP of the end EP of the data line DL may be tested.

For example, the data lines DL may include a first data line DL1, a second data line DL2, and a third data line DL3. Each of the first data line DL1, the second data line DL2, and the third data line DL3 may include internal resistances RI and parasitic capacitors CPR. The buffers OB may include a first output buffer OB1 connected to the first data line DL1, a second output buffer OB2 connected to the second data line DL2, and a third output buffer OB3 connected to the third data line DL3.

The first output buffer OB1 may include an input terminal, an inverting input terminal, and an output terminal. The input terminal of the first output buffer OB1 may receive a first data voltage VDATA1. The inverting input terminal of the first output buffer OB1 and the output terminal of the first output buffer OB1 may be connected to each other. The output terminal of the first output buffer OB1 may output the first data voltage VDATA1. The first output buffer OB1 may provide the first data voltage VDATA1 to the first data line DL1. The first data voltage VDATA1 may be transmitted to an end EP1 of the first data line DL1, and a slew rate of a first data voltage VDATA1 of the end EP1 of the first data line DL1 may be less than a slew rate SR1 of the first output buffer OB1.

The second output buffer OB2 may include an input terminal, an inverting input terminal, and an output terminal. The input terminal of the second output buffer OB2 may receive a second data voltage VDATA2. The inverting input terminal of the second output buffer OB2 and the output terminal of the second output buffer OB2 may be connected to each other. The output terminal of the second output buffer OB2 may output the second data voltage VDATA2. The second output buffer OB2 may provide the second data voltage VDATA2 to the second data line DL2. The second data voltage VDATA2 may be transmitted to an end EP2 of the second data line DL2, and a slew rate of a second data voltage VDATA2 of the end EP2 of the second data line DL2 may be less than a slew rate SR2 of the second output buffer OB2.

The third output buffer OB3 may include an input terminal, an inverting input terminal, and an output terminal. The input terminal of the third output buffer OB3 may receive a third data voltage VDATA3. The inverting input terminal of the third output buffer OB3 and the output terminal of the third output buffer OB3 may be connected to each other. The output terminal of the third output buffer OB3 may output the third data voltage VDATA3. The third output buffer OB3 may provide the third data voltage VDATA3 to the third data line DL3. The third data voltage VDATA3 may be transmitted to an end EP3 of the third data line DL3, and a slew rate of a third data voltage VDATA3 of the end EP3 of the third data line DL3 may be less than a slew rate SR3 of the third output buffer OB3.

The multiplexer MUX may be connected between the first to third data lines DL1, DL2, and DL3 and the test buffer TB. Specifically, the input terminal of the multiplexer MUX may be connected to the end EP1 of the first data line DL1, the end EP2 of the second data line DL2, and the end EP3 of the third data line DL3.

When the slew rate of the first data voltage VDATA1 of the end EP1 of the first data line DL1 is inspected, the multiplexer MUX may connect the first data line DL1 and the test buffer TB in response to the selection signal SEL. Accordingly, the multiplexer MUX may receive the first data voltage VDATA1_EP1 transmitted from the end EP1 of the first data line DL1 and provide the first data voltage VDATA1_EP1 of the end EP1 of the first data line DL1 to the test buffer TB. The test buffer TB may provide the first data voltage VDATA1_EP1 of the end EP1 of the first data line DL1 to the test pad TEST_PAD. The first data voltage VDATA1_EP1 of the end EP1 of the first data line DL1 output from the test pad TEST_PAD may be tested using the probe.

When the slew rate of the second data voltage VDATA2 of the end EP2 of the second data line DL2 is inspected, the multiplexer MUX may connect the second data line DL2 and the test buffer TB in response to the selection signal SEL. Accordingly, the multiplexer MUX may receive the second data voltage VDATA2_EP2 transmitted from the end EP2 of the second data line DL2 and provide the second data voltage VDATA2_EP2 of the end EP2 of the second data line DL2 to the test buffer TB. The test buffer TB may provide the second data voltage VDATA2_EP2 of the end EP2 of the second data line DL2 to the test pad TEST_PAD. The second data voltage VDATA2_EP2 of the end EP2 of the second data line DL2 output from the test pad TEST_PAD may be tested using the probe.

When the slew rate of the third data voltage VDATA3 of the end EP3 of the third data line DL3 is inspected, the multiplexer MUX may connect the third data line DL3 and the test buffer TB in response to the selection signal SEL. Accordingly, the multiplexer MUX may receive the third data voltage VDATA3_EP3 transmitted from the end EP3 of the third data line DL3 and provide the third data voltage VDATA3_EP3 of the end EP3 of the third data line DL3 to the test buffer TB. The test buffer TB may provide the third data voltage VDATA3_EP3 of the end EP3 of the third data line DL3 to the test pad TEST_PAD. The third data voltage VDATA3_EP3 of the end EP3 of the third data line DL3 output from the test pad TEST_PAD may be tested using the probe.

Referring to FIGS. 1 to 8, in the normal driving step, the first switch SW1 and the third switch SW3 may be open, and the second switch SW2 may be closed. Therefore, the multiplexer MUX and the test buffer TB may not affect an operation of the display device.

As such, the display panel 100 may further include the test buffer TB connected to the data line DL in a direction opposite to the output buffer OB. Accordingly, even without physically scratching the end of the data line DL to expose the end EP of the data line DL, the data voltage VDATA_EP of the end EP of the data line DL output from the test buffer TB may be tested.

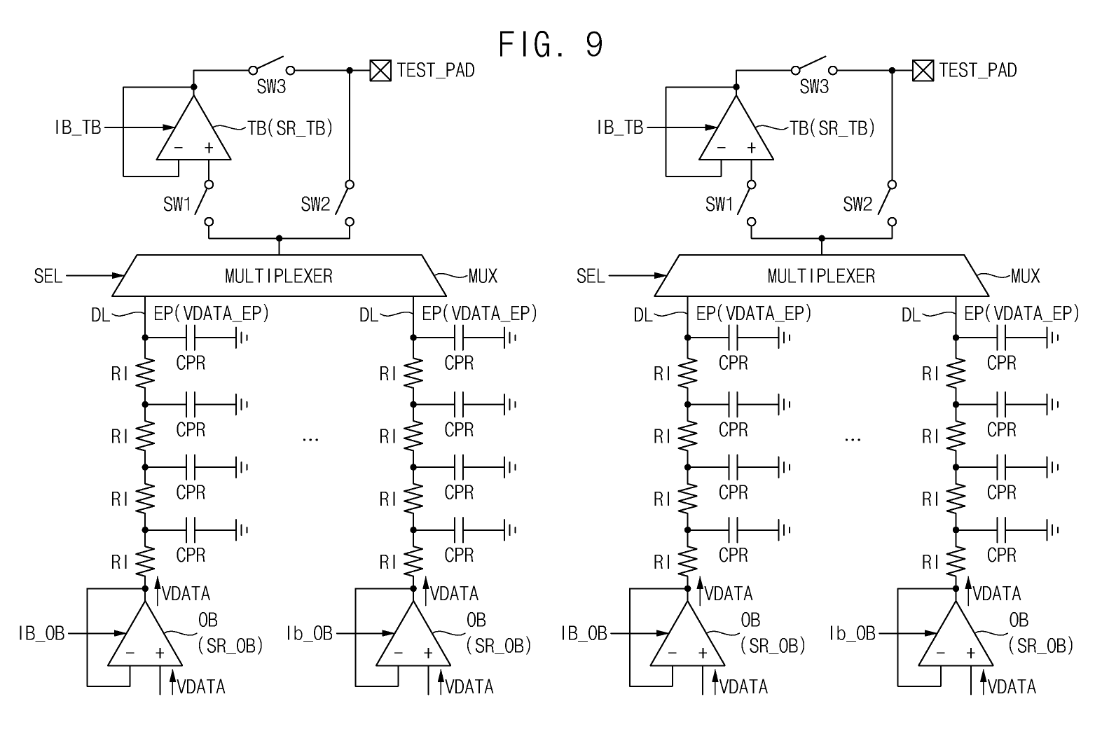

FIG. 9 is a circuit diagram showing an example of a display panel 100 including an output buffer OB and a data line DL according to embodiments of the present disclosure.

Referring to FIGS. 1 to 9, a display panel 100 including an output buffer OB and a data line DL of FIG. 9 is substantially equal to the display panel 100 including the output buffer OB and the data line DL of FIG. 6, except that the multiplexer MUX is omitted. Specifically, the display panel 100 of FIG. 6 may include one multiplexer MUX, whereas the display panel 100 of FIG. 9 may include at least two multiplexers MUX. Accordingly, a size of the multiplexers MUX may be prevented from becoming excessively large. In addition, since a number of data lines DL connected to each multiplexer MUX is reduced, a test time for each multiplexer MUX may also be reduced.

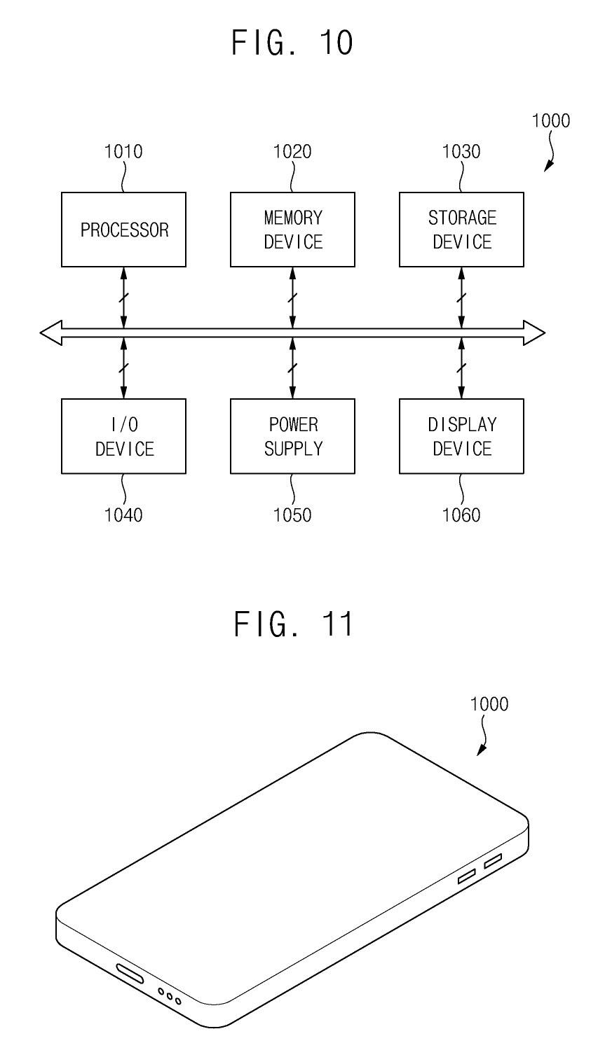

FIG. 10 is a block diagram showing an electronic device 1000 according to an embodiment of the present disclosure. FIG. 11 is a diagram showing an example in which an electronic device 1000 of FIG. 10 is implemented as a smart phone.

Referring to FIGS. 1 to 11, an electronic device 1000 may include a processor 1010, a memory device 1020, a storage device 1030, an input/output (I/O) device 1040, a power supply 1050 and a display device 1060. Here, the display device 1060 may be the display device of FIG. 1. In addition, the electronic device 1000 may further include a plurality of ports for communicating with a video card, a sound card, a memory card, a universal serial bus (USB) device, other electronic devices, etc.

In an embodiment, as shown in FIG. 11, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display device 1060 may be included in the I/O device 1040. The power supply 1050 may provide power for operations of the electronic device 1000. The display device 1060 may be coupled to other components via the buses or other communication links.

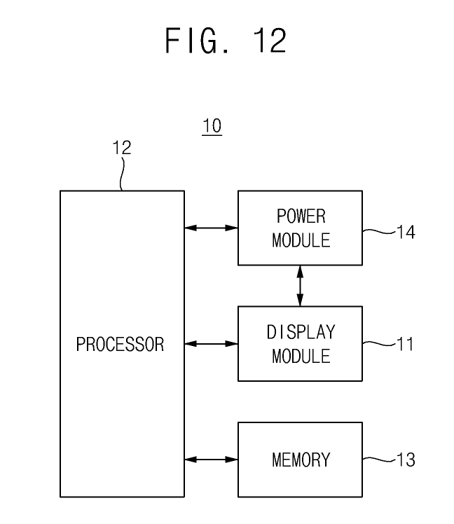

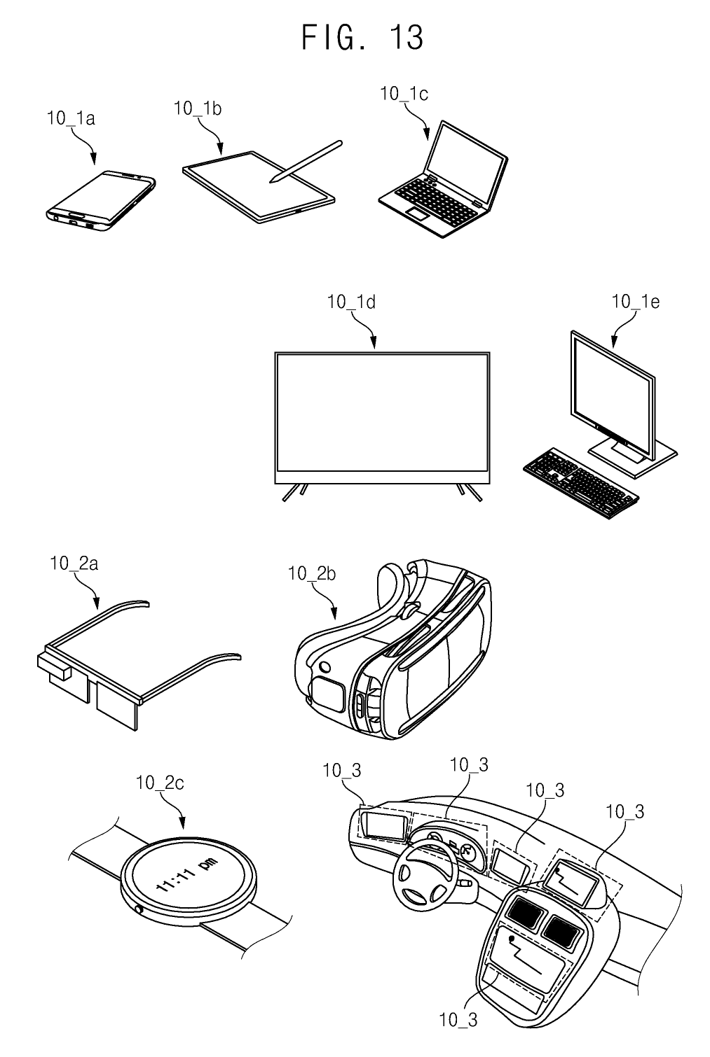

FIG. 12 is a block diagram showing an electronic device 10 according to an embodiment of the present disclosure. FIG. 13 is schematic diagrams showing electronic devices of FIG. 12.

Referring to FIG. 12, the electronic device 10 according to an embodiment may include a display module 11, a processor 12, a memory 13 and a power module 14.

The display device according to the embodiment of the present disclosure may be applied to various electronic devices.

In an embodiment, the electronic device 10 may include the display device of FIG. 1. An operation of the display device included in the electronic device 10 may be the same as the operation of the display device explained referring to FIGS. 1-9. The electronic device 10 may further include a module or an device having additional functions in addition to the display device.

The processor 12 may include at least one of a central processing unit (CPU), an application processor (AP), a graphic processing unit (GPU), a communication processor (CP), an image signal processor (ISP) and a controller.

In an embodiment, the processor 12 may provide the input control signal CONT of FIG. 1 and the input image data IMG of FIG. 1 to the driving controller 200 included in the display device of FIG. 1.

In an embodiment, the processor 12 may be divided into two or more in a functional or structural perspective. For example, the processor 12 may include a main processor, which is a first driving chip type, including the central processing unit and an auxiliary processor, which is a second driving chip type, including a controller receiving an image signal from the main processor and processing the image signal to match interface specifications of the display module 11. For example, the auxiliary processor may include the driving controller 200 included in the display device of FIG. 1. Thus, the main processor may provide the input control signal CONT of the FIG. 1 and the input image data IMG of FIG. 1 to the auxiliary processor. The auxiliary processor may process the image signal based on the input control signal CONT and the input image data IMG.

The memory 13 may include at least one of a nonvolatile memory and a volatile memory. Data information required for the operation of the processor 12 or the display module 11 may be stored in the memory 13. When the processor 12 executes an application stored in the memory 13, the input control signal CONT and/or the input image data IMG may be transmitted to the display module 11 and the display module 11 may process the input control signal CONT and/or the input image data IMG and may output image information through a display area.

The power module 14 may include a power supply module, such as a power adapter or a battery device, and a power conversion module converting power supplied by the power supply module to generate a power required for the operation of the electronic device 10.

At least one of the elements of the electronic device 10 may be included in the display device according to embodiments of the present disclosure. In addition, a part of a single functional module may be included in the display device, and another part of the single functional module may be disposed out of the display device. For example, the display module 11 may be included in the display device but the processor 12, the memory 13 and the power module 14 may be included in another device in the electronic device 10 which is not the display device.

Referring to FIG. 13, the various electronic devices including the display device according to the present embodiments may include electronic devices for displaying image such as a smartphone 10_1a, a tablet PC 10_1b, a laptop 10_1c, a television 10_1d, a desktop monitor 10_1e, wearable electronic devices including a display module such as smart glasses 10_2a, a head mounted display 10_2b and a smart watch 10_2c and vehicle electronic devices 10_3 including display modules such as a CID (center information display), a room mirror display disposed on an instrument panel, center fascia, and a dashboard of a vehicle. The electronic device 10 may not be limited to the electronic devices for displaying image, the wearable electronic devices and the vehicle electronic devices 10_3.

According to the driver, the display device that includes the driver, and the electronic device that includes the driver of the present disclosure, the power consumption of the display device may be reduced.

The foregoing is illustrative of aspects of the present disclosure and is not to be construed as limiting thereof. Although a few example embodiments of the present disclosure have been described, those skilled in the art will readily appreciate that many modifications are possible in the example embodiments without materially departing from the novel teachings and advantages of the present disclosure. Accordingly, all such modifications are intended to be included within the scope of the present disclosure. In the claims, means-plus-function clauses are intended to cover the structures described herein as performing the recited function and not only structural equivalents but also equivalent structures.

Although the present display device and electronic device have been described with reference to the embodiments shown in the drawings, these are merely exemplary, and those skilled in the art will understand that various modifications and equivalent other embodiments are possible therefrom. Therefore, the disclosed subject matter should not be limited to any single embodiment described herein.

What is claimed is:

1. A display device, comprising:
a display panel comprising one or more data lines and a plurality of pixels, each pixel of the plurality of pixels being connected to a data line of the one or more data lines, each data line of the one or more data lines having a first end and a second end;
one or more data drivers, each data driver of the one or more data drivers comprising:
an output buffer connected to a respective data line of the one or more data lines at the first end of the data line, and the output buffer being configured to provide a data voltage to the respective data line with which the output buffer is connected; and
a driving controller configured to control each data driver of the one or more data drivers,
wherein the display panel further includes a test buffer, the test buffer being connected to each data line of the one or more data lines at the second end of the data line.

2. The display device of claim 1, wherein a slew rate of the output buffer is determined such that a slew rate of a data voltage of the second end of the data line of each data driver is equal to or greater than a threshold slew rate.

3. The display device of claim 1, wherein a slew rate of the test buffer is greater than a slew rate of the output buffer.

4. The display device of claim 3, wherein a bias current of the test buffer is greater than a bias current of the output buffer.

5. The display device of claim 1, wherein the display panel further comprises one or more multiplexers connected to the test buffer, a multiplexer of the one or more multiplexers being configured to connect one data line of the one or more data lines to the test buffer in response to receiving a selection signal, wherein the one or more data lines includes at least two data lines.

6. The display device of claim 5, wherein the one or more multiplexers comprises at least two multiplexers.

7. The display device of claim 5, wherein the display panel further includes:
a first switch connected between an input terminal of the test buffer and an output terminal of the multiplexer of the one or more multiplexers;
a second switch connected between a test pad and the output terminal of the multiplexer of the one or more multiplexers; and
a third switch connected between the test pad and an output terminal of the test buffer.

8. The display device of claim 7, wherein, in a testing step, the first switch and the third switch are closed, and the second switch is open, and
in a normal driving step other than the testing step, the first switch and the third switch are open, and the second switch is closed.

9. The display device of claim 8, wherein, in the testing step, a slew rate of the data voltage output from the output terminal of the test buffer is tested.

10. The display device of claim 1, wherein the data driver and the driving controller are included in a display panel driver.

11. An electronic device, comprising:
a display panel comprising one or more data lines and a plurality of pixels, each pixel of the plurality of pixels being connected to a data line of the one or more data lines, each data line of the one or more data lines having a first end and a second end;
one or more data drivers, each data driver of the one or more data drivers comprising:
an output buffer connected to a respective data line of the one or more data lines at the first end of the data line, and the output buffer being configured to provide a data voltage to the respective data line with which the output buffer is connected;
a driving controller configured to control each data driver of the one or more data drivers; and
a processor configured to control the driving controller,
wherein the display panel further includes a test buffer, the test buffer being connected to each data line of the one or more data lines at the second end of the data line.

12. The electronic device of claim 11, wherein a slew rate of the output buffer is determined such that a slew rate of a data voltage of the second end of the data line of each data driver is equal to or greater than a threshold slew rate.

13. The electronic device of claim 11, wherein a slew rate of the test buffer is greater than a slew rate of the output buffer.

14. The electronic device of claim 13, wherein a bias current of the test buffer is greater than a bias current of the output buffer.

15. The electronic device of claim 11, wherein the display panel further comprises one or more multiplexers connected to the test buffer,
a multiplexer of the one or more multiplexers being configured to connect one data line of the one or more data lines to the test buffer in response to receiving a selection signal, wherein the one or more data lines includes at least two data lines.

16. The electronic device of claim 15, wherein the one or more multiplexers comprises at least two multiplexers.

17. The electronic device of claim 15, wherein the display panel further includes:
a first switch connected between an input terminal of the test buffer and an output terminal of the multiplexer of the one or more multiplexers;
a second switch connected between a test pad and the output terminal of the multiplexer of the one or more multiplexers; and
a third switch connected between the test pad and an output terminal of the test buffer of the one or more multiplexers.

18. The electronic device of claim 17, wherein, in a testing step, the first switch and the third switch are closed, and the second switch is open, and
in a normal driving step other than the testing step, the first switch and the third switch are open, and the second switch is closed.

19. The electronic device of claim 18, wherein, in the testing step, a slew rate of the data voltage output from the output terminal of the test buffer is tested.

20. The electronic device of claim 11, wherein the data driver and the driving controller are included in a display panel driver.
